(19) United States
(12) Patent Application Publication
(10) Pub. No.: US 2023/0408542 A1
(43) Pub. Date: Dec. 21, 2023

(54) AUTOMATED INLINE NANOPARTICLE STANDARD MATERIAL ADDITION

(71) Applicant: Elemental Scientific, Inc., Omaha, NE (US)

(72) Inventor: Austin Schultz, Omaha, NE (US)

(21) Appl. No.: 18/205,131

(22) Filed: Jun. 2, 2023

Related U.S. Application Data
(60) Provisional application No. 63/350,642, filed on Jun. 9, 2022.

(51) Int. Cl. G01N 35/10; H01J 49/10

(52) U.S. Cl. CPC G01N 35/1097; G01N 2035/00524; H01J 49/105

(57) ABSTRACT

Systems and methods for automated handling and maintaining nanoparticle standard solutions in a substantially homogenous state with controlled introduction to a fluid sample are described. A system embodiment includes, but is not limited to, an agitator configured to mix a nanoparticle standard solution in a container to provide a mixed nanoparticle standard having a substantially homogenous distribution of nanoparticles; and a fluid preparation system fluidically coupled with the container to receive the mixed nanoparticle standard and direct the mixed nanoparticle standard to a fluid sample stream for inline mixing therewith.

### CROSS-REFERENCE TO RELATED APPLICATIONS

The present application claims the benefit of 35 U.S.C. § 119(e) of U.S. Provisional Application Ser. No. 63/350,642, filed Jun. 9, 2022, and titled “AUTOMATED INLINE NANOPARTICLE STANDARD MATERIAL ADDITION.” U.S. Provisional Application Ser. No. 63/350,642 is herein incorporated by reference in its entirety.

### BACKGROUND

Inductively coupled plasma (ICP) mass spectroscopy is an analysis technique commonly used for the determination of trace element concentrations and isotope ratios in liquid samples. ICP mass spectroscopy employs electromagnetically generated partially ionized argon plasma which reaches a temperature of approximately 7000K. When a sample is introduced to the plasma, the high temperature causes sample atoms to become ionized or emit light. Since each chemical element produces a characteristic mass or emission spectrum, measuring said spectra allows the determination of the elemental composition of the original sample.

Sample introduction systems may be employed to introduce the liquid samples into the ICP mass spectroscopy instrumentation (e.g., an inductively coupled plasma mass spectrometer (ICP/ICPMS), an inductively coupled plasma atomic emission spectrometer (ICP-AES), or the like) for analysis. For example, a sample introduction system may withdraw an aliquot of a liquid sample from a container and thereafter transport the aliquot to a nebulizer that converts the aliquot into a polydisperse aerosol suitable for ionization in plasma by the ICP mass spectrometry instrumentation. The aerosol is then sorted in a spray chamber to remove the larger aerosol particles. Upon leaving the spray chamber, the aerosol is introduced to the ICPMS or ICPAES instruments for analysis. Often, the sample introduction is automated to allow a large number of samples to be introduced into the ICP mass spectroscopy instrumentation in an efficient manner.

### SUMMARY

Systems and methods for automated handling of homogenous nanoparticle standard solutions with subsequent inline introduction to sample solutions prior to analysis are described. A system embodiment includes, but is not limited to, an agitator configured to mix a nanoparticle standard solution in a container to provide a mixed nanoparticle standard having a substantially homogenous distribution of nanoparticles; and a fluid preparation system fluidically coupled with the container to receive the mixed nanoparticle standard, the fluid preparation system including a valve system and one or more pumps configured to direct the mixed nanoparticle standard through the valve system and into contact with a fluid sample stream for inline mixing with the fluid sample stream to provide a mixed sample and nanoparticle standard fluid prior to transfer to an analysis system.

A method embodiment includes, but is not limited to, mixing, via an agitator, a nanoparticle standard solution in a container to provide a mixed nanoparticle standard having a substantially homogenous distribution of nanoparticles; transferring, via a fluid line, the mixed nanoparticle standard to a fluid preparation system including a valve system and one or more pumps; and directing, via the one or more pumps, the mixed nanoparticle standard through the valve system and into contact with a fluid sample stream to inline mix with the fluid sample stream and provide a mixed sample and nanoparticle standard fluid prior to transfer to an analysis system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures.

FIG. 1 is a schematic illustration of a system for handling and maintaining nanoparticle standard solutions in a substantially homogenous state with controlled introduction to a fluid sample in accordance with example implementations of the present disclosure.

FIG. 2 is a schematic illustration of an embodiment of the system of FIG. 1 shown in a nanoparticle standard agitation state, in accordance with example implementations of the present disclosure.

FIG. 3 is a schematic illustration of the system of FIG. 2, shown in a nanoparticle standard load state with operation of a vacuum loader, in accordance with example implementations of the present disclosure.

FIG. 4 is a schematic illustration of the system of FIG. 2, shown in a nanoparticle standard loaded state with the vacuum loader disabled, in accordance with example implementations of the present disclosure.

FIG. 5 is a schematic illustration of the system of FIG. 2, shown in a nanoparticle standard introduction state with the standard introduced to a flowing sample stream, in accordance with example implementations of the present disclosure.

FIG. 6 is a schematic illustration of the system of FIG. 2, shown in a standard rinse state to rinse fluid lines previously carrying the standard, in accordance with example implementations of the present disclosure.

FIG. 7 is a schematic illustration of the system of FIG. 2, shown in a purge state to introduce a purge gas to the rinsed fluid lines, in accordance with example implementations of the present disclosure.

### DETAILED DESCRIPTION

### Overview

Nanoparticle research has grown to encompass applications from the medical industry to the environmental industry. Such applications can focus on capabilities to detect nanoparticles (e.g., particles of less than 1000 nm in diameter) and to calculate the sizes of nanoparticles present in a sample. However, determining what is a nanoparticle and what is not a nanoparticle when analyzing spectrometry data poses many challenges. For instance, spectrometry data, such as ICPMS data, includes information associated with ionized samples and background interference, such as resulting from plasma gases introduced to the ICP torch, that can overlap with data associated with small nanoparticles. For example, as the size of the nanoparticle decreases, the spectrometry data of the nanoparticle begins to converge with data associated with ionic species produced by the ICP torch. This overlap and the associated challenges with removing background interferences, while avoiding nanoparticle data removal, lead to continued problems in providing reliable data associated with nanoparticles, including, but not limited to, identification of nanoparticles and determining the number of nanoparticles and their associated size distributions.

Nanoparticle standards or reference materials (RMs) can be utilized to determine transport efficiency of samples that could contain nanoparticles, providing an opportunity to determine nanoparticle concentration and nanoparticle size in the sample based on the known standards. Example nanoparticle standards can include suspensions of gold nanoparticles provided in a liquid matrix, where the standard suspensions include nanoparticles having a known concentration and size or size distribution. The nanoparticle standards can vary depending on the desired sample analysis, where the material of nanoparticles, the matrix of the nanoparticles, the concentration of the nanoparticles, the size of the nanoparticles, or the like, or combinations thereof can change between samples.

Since many nanoparticle standards can be utilized for sample analyses, various containers of the nanoparticle standards may be idle while awaiting use, which can cause nanoparticles to settle within the container. Settling of the nanoparticles can negatively affect the concentration of the standards by providing localized concentration differences within the container, where drawing a volume of standard from within the container may result in a concentration of nanoparticles that significantly differs from the purported standard concentration. While the container can be mixed prior to use, the task of mixing can be time-consuming when multiple sample containers are awaiting analysis at an autosampler. For instance, prolonged mixing of the nanoparticle standard can cause damage to the nanoparticles, preventing bulk mixing of multiple containers. Moreover, the nanoparticle standard often cannot preloaded into a sample container prior to uptake by an autosampler probe (e.g., by directly introducing the standard into a sample container of a sample waiting to be analyzed), since many chemicals provided in the sample can dissolve or otherwise damage the nanoparticles in the standard, preventing an accurate analysis, particularly where a significant duration of time passes between introduction of the standard and uptake of the mixed sample and standard by the autosampler. Thus, a laboratory staff member typically adds the nanoparticle standards to a sample just prior to sample analysis to minimize the time the sample interacts with the nanoparticle standard. For multiple samples, the laboratory staff has numerous tasks to prepare the standards and samples for analysis to avoid damage to the nanoparticle standards, resulting in high costs, multiple opportunities for introduction of error (e.g., incorrect standard used for a particle sample, incorrect volume of standard used, incorrect time of introduction of standard, etc.), and other inefficiencies in sample analysis.

Accordingly, in one aspect, the present disclosure is directed to systems and methods for automated handling of homogenous nanoparticle standard solutions with subsequent introduction to one or more fluid samples with automated inline introduction to the fluid sample at a designated time prior to analysis. A system embodiment includes an agitator to mix a nanoparticle standard container prior to drawing a volume of homogenized nanoparticle standard into an isolated fluid path having a precise volume (e.g., via pump or vacuum introduction). The system can include a pump system and a valve system to direct the nanoparticle standard from the isolated fluid path into a sample stream to mix with the sample while the sample is directed to a sample analysis system (e.g., to a nebulizer of an ICP analysis system). The system can automatically introduce, between samples, a rinse fluid into the fluid path used to transfer and isolate the nanoparticle solution to clean the fluid lines prior to introduction of a different nanoparticle standard. A purge gas can follow the rinse fluid to remove trace amounts of rinse fluid in the fluid lines to prevent mixture between the rinse fluid and subsequent nanoparticle standards (e.g., to avoid imprecise dilution therebetween).

### Example Implementations

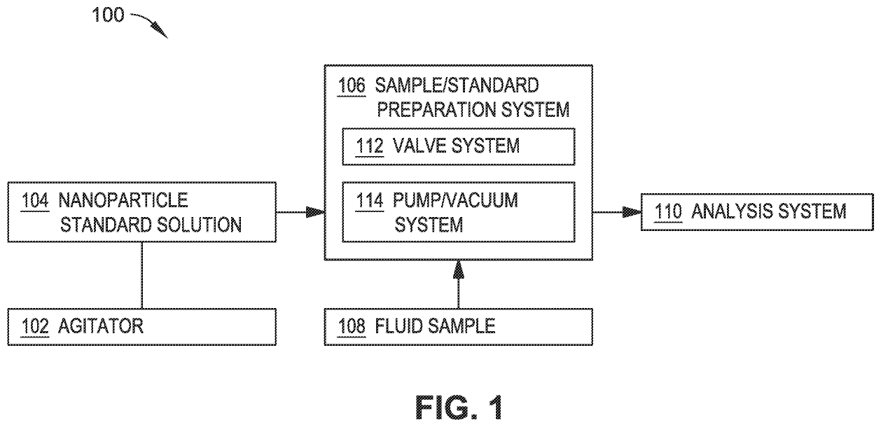

Referring generally to FIGS. 1 through 7, a system 100 is shown for automated handling and maintaining nanoparticle standard solutions in a substantially homogenous state with controlled introduction to a fluid sample to prevent breakdown of nanoparticles present in the nanoparticle standard solutions. As used herein, the term “nanoparticle standard solution” encompasses all forms of solid or semisolid nanoparticles present in a fluid matrix, and can include solid-liquid suspensions, solid-liquid solutions, and the like. The system 100 generally includes an agitator 102 to mix one or more nanoparticle standard solutions 104 to provide a substantially homogenous distribution of nanoparticles within each solution and a fluid preparation system 106 to receive the mixed nanoparticle solutions 104 and one or more fluid samples 108 to prepare the fluid samples and nanoparticle standards for introduction to an analysis system 110. The agitator 102 can include, but is not limited to, a platform shaker, a rotating mixer, an ultrasonic mixer, a magnetic stir mixer, a rocking mixer, or the like, or combinations thereof. The agitator 102 can facilitate mixing of one or more containers holding a nanoparticle standard solution 104 through use of one or more agitator structures. For example, the agitator 102 can include a first mixer to mix a single container or multiple containers holding the same or different nanoparticle standard solutions 104, can include a second mixer to mix a single container or multiple containers holding the same or different nanoparticle standard solutions 104, and the like. When the agitator 102 includes multiple mixing structures, the agitator 102 can provide individualized mixing of each container or groups of containers. For example, the agitator 102 can mix a first container of nanoparticle standard solution 104 while a second container of nanoparticle standard solution 104 remains idle (e.g., not mixed). Permitting the second container of nanoparticle standard solution 104 to remain idle until needed for analysis can prevent stresses associated with mixing of the nanoparticles from breaking down the nanoparticles into uncalibrated sizes/shapes (e.g., due to impact with the vessel, due to impact with other nanoparticles, or the like). In implementations, the system 100 can include a chilling device, such as a Peltier cooler, to cool one or more fluids transitioned through the system 100. For example, the agitator 102 can include a Peltier cooler to maintain one or more of the nanoparticle standard solutions 104 at a temperature below ambient temperature.

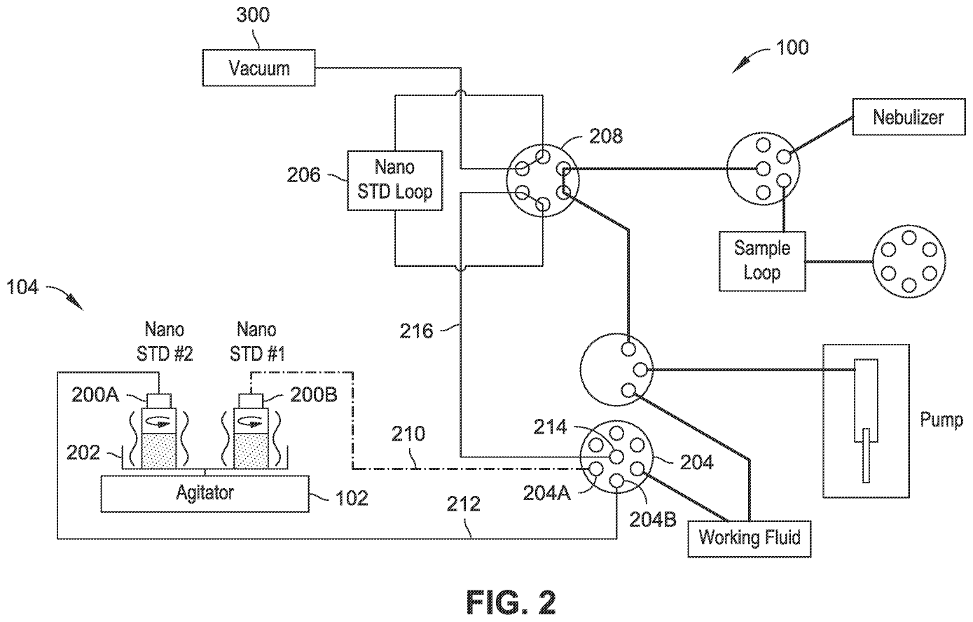

The fluid preparation system 106 can include a valve system 112 including one or more valves and a pump/vacuum system 114 including one or more pumps and/or one or more vacuum sources to facilitate automated transport of fluids through the system 100. An example fluid preparation system 106 is described further herein with reference to FIGS. 2 through 7. The analysis system 110 receives fluids from the fluid preparation system 106 for analytic determination of one or more components of the fluids, such as analyte concentrations, nanoparticle sizes, nanoparticle concentrations, and the like. For example, the analysis system 110 can include, but is not limited to, one or more ICP spectroscopy instruments, such as an ICPMS instrument, and associated sample preparation instruments, such as a nebulizer, an ICP torch, and the like.

Referring to FIGS. 2 through 7, an example of the system 100 is shown with the system 100 transitioned between states (e.g., through operation of the valve system 112 and the pump/vacuum system 114) to facilitate handling of the nanoparticle standard solution 104 for automatic, inline introduction to the fluid sample 108. The system 100 includes two containers of nanoparticle standards (shown as 200A, 200B) supported by a tray 202 of the agitator 102 to impart motion to the containers 200A, 200B to mix the nanoparticles and the matrix fluids to provide substantially homogenous nanoparticle standard solutions. While two containers are shown, the system 100 is not limited to two containers and can support one container or more than two containers without deviating from the scope of the instant disclosure. Further, while one agitator 102 with one tray 202 is shown supporting both containers of nanoparticle standards, it can be appreciated that individual agitators 102 and/or individual trays 202 can be utilized to mix the nanoparticles and the matrix fluid from individual containers to provide substantially homogenous nanoparticle standard solutions independent from the other containers. Independent mixing of individual containers can avoid mixing of nanoparticle solutions that are not utilized for one or more upcoming samples for analysis to prevent stresses associated with mixing of the nanoparticles until the specific nanoparticle standard is scheduled to be utilized for a sample at which point the system 100 can mix that specific nanoparticle standard.

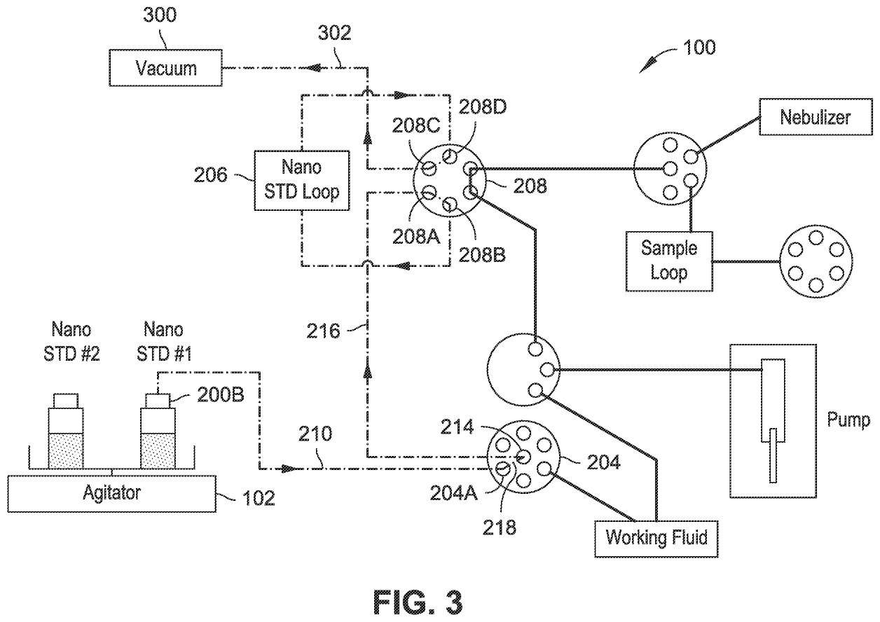

The system 100 is shown in FIG. 2 in a nanoparticle standard agitation state where the agitator 102 is activated to mix the nanoparticle standard containers 200A, 200B. The containers 200A, 200B are fluidically coupled with a selector valve 204 that individually selects a container to fluidically couple with a standard holding loop 206 via a valve 208. In implementations, the selector valve 204 is a valve assembly described in U.S. Pat. No. 9,541,207, which is incorporated by reference herein, to select one of a plurality of ports to couple with a distribution port via a selection channel and direct fluid from the selected port out the distribution port. For example, the container 200A is fluidically coupled with the selector valve 204 via a fluid line 210 connected to a first port (e.g., port 204A) and the container 200B is fluidically coupled with the selector valve 204 via a fluid line 212 connected to a second port (e.g., 204B), where additional ports of the selector valve 204 can be coupled with additional nanoparticle standard containers. The selector valve 204 can fluidically couple the selected port to a distribution port (e.g., port 214) via a selection channel (e.g., channel 218 shown in FIG. 3) to transfer fluid received from the selected port through the distribution port to the valve 208 via a fluid line 216.

Referring to FIG. 3, the system 100 is shown in an example nanoparticle standard load state with the container 200B fluidically coupled with the standard holding loop 206 via the selector valve 204 and the valve 208 in a load configuration. In the load configuration, the valve 208 fluidically couples the standard holding loop 206 and a vacuum loader 300 (e.g., pump, negative pressure source, vacuum pump, etc.). When the vacuum loader 300 is operated, nanoparticle standard from the container 200B is drawn through the selector valve 204 via fluid line 210, selection channel 218, and fluid line 216 and into the valve 208 where the fluid is directed into the standard holding loop 206. For example, the fluid line 216 can be coupled with a first port (e.g., port 208A) of the valve 208, where the valve 208 fluidically couples the first port with a second port (e.g., port 208B) in the load configuration to fluidically couple the fluid line 216 with the standard holding loop 206. With the valve 208 in the load configuration, the vacuum 300 is fluidically coupled with the standard holding loop 206 via a fluid line 302 coupled with a third port (e.g., port 208C) and the valve 208 fluidically couples the third port with a fourth port (e.g., port 208D) to fluidically couple the fluid line 302 with the standard holding loop 206.

In implementations, the vacuum loader 300 is operated for a duration to draw the substantially homogenous nanoparticle standard solution from container 200B to fill the entire standard holding loop 206, with excess standard solution pulled back into the valve 208 (e.g., towards the vacuum loader) in the fluid line 302. For example, the standard holding loop 206 can be a fluid line (e.g., fluid coil, etc.) having a known volume such that the valve 208 can trap a precise amount of the nanoparticle standard within the standard holding loop 206. In implementations, the standard holding loop 206 is a 0.5 mL volume holding loop, however the system 100 is not limited to such size of holding loop and can include the standard holding loop 206 with volumes less than 0.5 mL or volumes greater than 0.5 mL.

During the load configuration, the agitator 102 can be in a deactivated state where no agitation or mixing of the nanoparticle standards is occurring (e.g., as shown in FIG. 3), or the agitator 102 can be in an activated state where agitation or mixing of the nanoparticle standards is occurring for a portion or all of the duration of loading the nanoparticle standard into the standard holding loop 206.

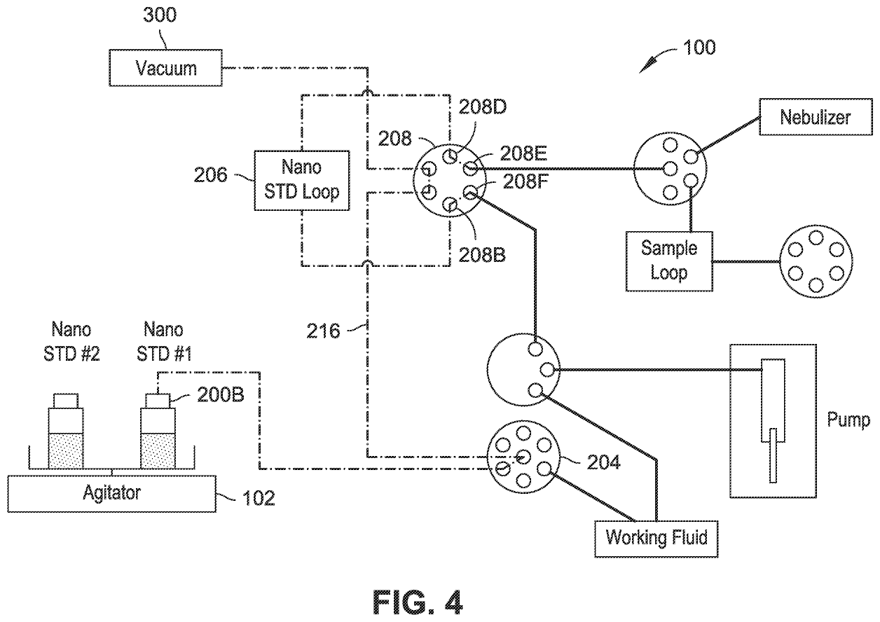

Referring to FIG. 4, the system 100 is shown in a nanoparticle standard loaded state with the nanoparticle standard fully loaded in the standard holding loop 206. When the standard holding loop 206 is loaded, the system 100 transitions the valve 208 from the load configuration to an inject configuration. The inject configuration of the valve 208 decouples the vacuum loader 300 from the standard holding loop 206 to prevent further drawing of nanoparticle standard from the containers (e.g., containers 200A, 200B) through the standard holding loop 206. For example, the valve 206 can fluidically connect the fourth port 208D with a fifth port (e.g., port 208E) and fluidically connect the second port 208B with a sixth port (e.g., port 208F) to prepare for transfer of the nanoparticle standard solution from the standard holding loop 206. In implementations, the valve 208 can include one or more fluid sensors to detect fluid entering or leaving the standard holding loop 206 to determine when the standard holding loop 206 is filled. Alternatively or additionally, the system 100 includes a timer used to control operation time of the vacuum loader 300 to provide a duration suitable to fill the standard holding loop 206.

In implementations, the inject configuration of the valve 208 fluidically couples the vacuum loader 300 and the selection valve 204. For example, in the inject configuration, the valve 208 fluidically couples the first port 208A with the third port 208C to fluidically couple the vacuum loader 300 with the selection valve 204, bypassing the standard holding loop 206. The system 100 can deactivate the vacuum loader 300 when the system 100 is in the nanoparticle standard loaded state to prevent further drawing of nanoparticle standard from the containers (e.g., containers 200A, 200B), which can permit the system 100 to minimize the amount of standard used for each analysis.

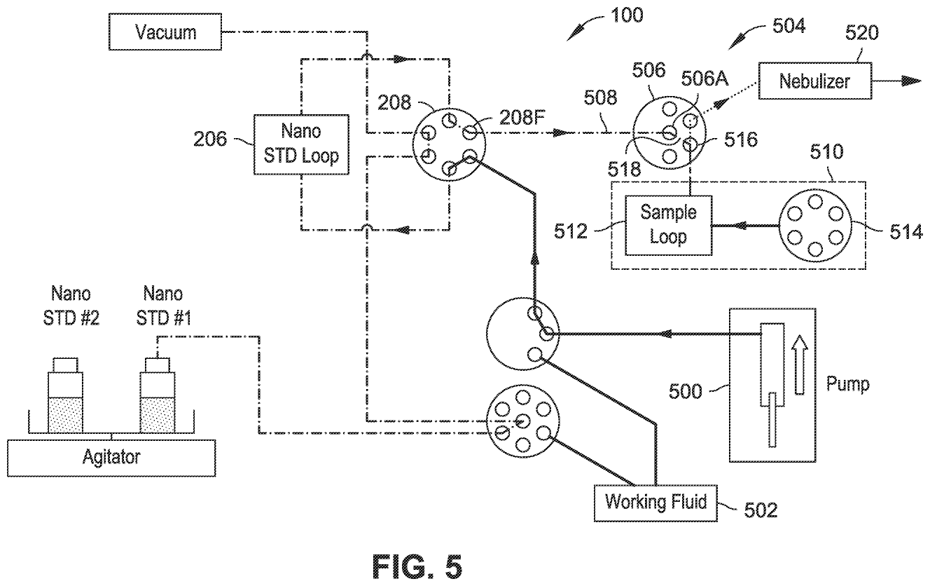

Referring to FIG. 5, the system 100 is shown in a nanoparticle standard introduction state. The system 100 can include a pump 500 (e.g., a syringe pump is shown) fluidically coupled with the valve 208 in the inject state, with the standard holding loop 206 fluidically coupled with the pump 208 via the valve 208. The pump 500 can introduce a working fluid, such as water (e.g., ultrapure water source 502 is shown), to push the nanoparticle standard solution held in the standard holding loop 206 through the valve 208 and toward a sample mixing portion 504 of the system 100. In implementations, the sample mixing portion 504 includes a valve 506 fluidically coupled with the valve 208 to receive the nanoparticle standard pushed from the standard holding loop 206. For example, the valve 208 is fluidically coupled with the valve 506 via a fluid line 508 coupled between the sixth port 208F and a port 506A of the valve 506.

The valve 506 can be a selector valve as described with reference to selector valve 204 to mix two incoming fluid streams, such as a fluid sample with the nanoparticle standard solution. For instance, the valve 506 is also fluidically coupled with a sample inlet portion 510 configured to supply a fluid sample to the valve 506 (e.g., for mixing of the sample and the nanoparticle standard prior to sending the fluid sample to the analysis system 110). For example, the sample inlet portion 510 is shown with a diluted sample loop 512 configured to hold a particular volume of fluid sample and a sample valve 514 fluidically coupled with a sample source to receive a fluid sample, such as a diluted fluid sample, from another portion of the system 100 (not shown). In implementations, the fluid sample can be sourced from an autosampler of the system 100, however the disclosure is not limited to such configuration. The valve 506 is shown including a mixing port 516 to receive nanoparticle standard solution from fluid line 508 via a selection channel 518 and sample from the sample inlet portion 510 to mix the fluids inline to provide a mixed sample and standard fluid to a nebulizer 520 (e.g., a nebulizer of the analysis system 110). By mixing the sample and the nanoparticle standard solution inline in the valve 506 just prior to transfer for the nebulizer 520, the system 100 provides minimal contact time between the sample and the nanoparticle standard solution prior to analysis by the analysis system 100, which can prevent or otherwise mitigate against chemicals provided in the sample from dissolving or otherwise damaging the nanoparticles in the standard.

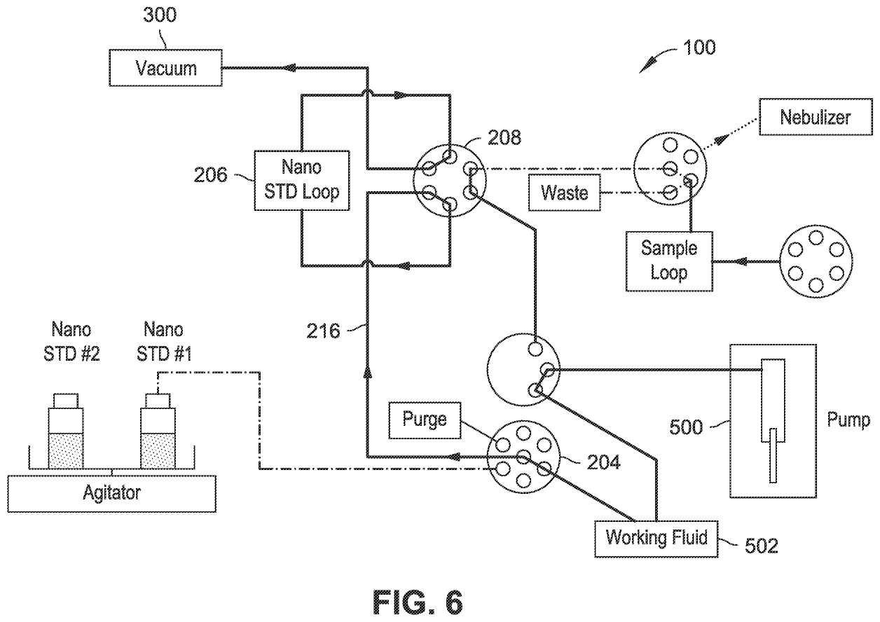

The system 100 can also facilitate automated rinsing of fluid flow pathways between drawing and injecting nanoparticle standards to remove trace amounts of nanoparticle standard that might remain adhered to fluid lines, valves, or the like. For example, referring to FIG. 6, the system 100 is shown in a standard rinse state with the selection valve 204 fluidically coupled with the working fluid 502 and with the valve 208 in the load configuration to fluidically couple the vacuum loader 300 and the standard holding loop 206 with the selection valve 204. The system 100 can activate the vacuum loader 300 to draw rinse fluid (e.g., ultrapure water) through the fluid line 216 coupled between the selection valve 204 and the valve 208, through the valve 208, and through the standard holding loop 206 to rinse the portions of any trace nanoparticle standard. In implementations, the pump 500 can be loaded with rinse fluid (e.g., from the ultrapure water source 502) in preparation to rinse the fluid line 508 and the valve 506.

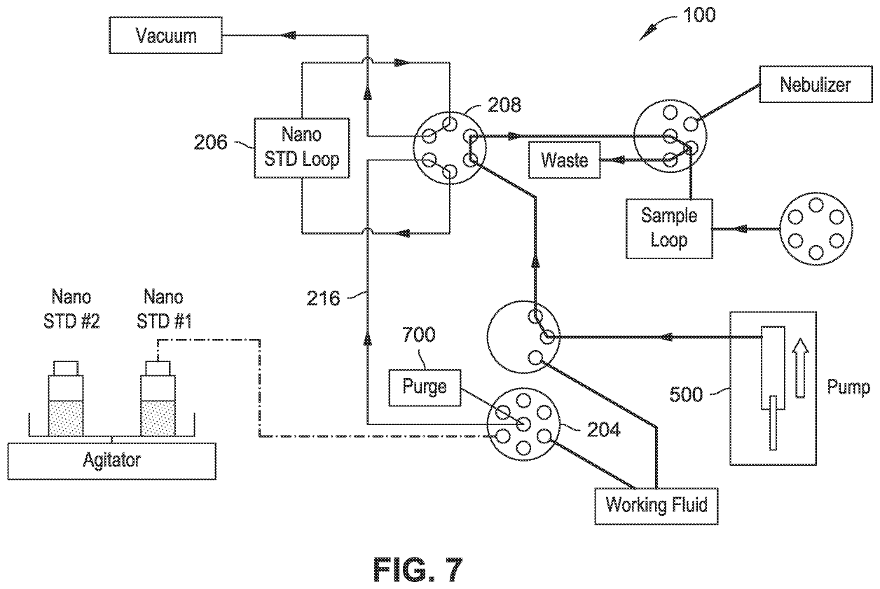

Referring to FIG. 7, the system 100 is shown in a purge state to introduce a purge gas into fluid lines and valves to remove any residual rinse fluid. For example, the selection valve 204 is shown fluidically coupled with a purge gas source 700 to direct purge gas through the fluid line 216 and into the valve 208 in the load configuration to push purge gas through the standard holding loop 206. The purge gas can include, but is not limited to, argon, nitrogen, an inert gas, or the like, or combinations thereof. The pump 500 is shown injecting the rinse fluid into the valve 208 which directs the rinse fluid into the fluid line 508 and the valve 506 to rinse the fluid line 508 of any trace nanoparticle standard solution. In implementations, the system 100 can subsequently direct purge gas from the purge gas source into the fluid line 508 to remove any residual rinse fluid.

Electromechanical devices (e.g., electrical motors, servos, actuators, or the like) may be coupled with or embedded within the components of the system 100 to facilitate automated operation via control logic embedded within or externally driving the system 100. The electromechanical devices can be configured to cause movement of devices and fluids according to various procedures, such as the procedures described herein. The system 100 may include or be controlled by a computing system having a processor or other controller configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to the agitator 102, the vacuum loader 300, valves described herein, pumps described herein, other components described herein, components directing control thereof, or combinations thereof. The program instructions, when executed by the processor or other controller, can cause the computing system to control the system 100 (e.g., control pumps, selection valves, actuators, positioning devices, etc.) according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors or other controllers, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### CONCLUSION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A system for automated handling of nanoparticle standard fluids for spectroscopy, comprising:
an agitator configured to mix a nanoparticle standard solution in a container to provide a mixed nanoparticle standard having a substantially homogenous distribution of nanoparticles; and
a fluid preparation system fluidically coupled with the container to receive the mixed nanoparticle standard, the fluid preparation system including a valve system and one or more pumps configured to direct the mixed nanoparticle standard through the valve system and into contact with a fluid sample stream for inline mixing with the fluid sample stream to provide a mixed sample and nanoparticle standard fluid prior to transfer to an analysis system.

2. The system of claim 1, wherein the fluid preparation system further includes a nanoparticle standard loop, wherein the valve system includes a load configuration configured to fluidically couple the container with the nanoparticle standard loop.

3. The system of claim 2, wherein the one or more pumps include a vacuum loader, and wherein the valve system fluidically couples the vacuum loader with each of the nanoparticle standard loop and the container in the load configuration to permit the vacuum loader to draw the mixed nanoparticle standard into the nanoparticle standard loop.

4. The system of claim 2, wherein the valve system includes an inject configuration configured to fluidically couple the nanoparticle standard loop with the fluid sample stream.

5. The system of claim 4, wherein the valve system includes a valve having a mixing port that fluidically couples a fluid line configured to transfer the mixed nanoparticle standard from the nanoparticle standard loop with a fluid line configured to transfer the fluid sample stream to permit inline mixing between the mixed nanoparticle standard and the fluid sample stream to provide a mixed sample and standard fluid stream.

6. The system of claim 5, further comprising the analysis system, wherein the valve system is configured to direct the mixed sample and standard fluid stream to the analysis system.

7. The system of claim 4, wherein the valve system fluidically decouples the nanoparticle standard loop from the container with the valve system in the inject configuration.

8. The system of claim 2, wherein the one or more pumps include a pump fluidically coupled with a working fluid source, the pump configured to introduce a working fluid from the working fluid source into the nanoparticle standard loop with the valve system in the inject configuration to push the mixed nanoparticle standard out of the nanoparticle standard loop.

9. The system of claim 1, wherein the valve system includes a purge configuration configured to fluidically couple with a purge gas source to direct purge gas through at least a portion of system.

10. The system of claim 1, wherein the agitator is configured to selectively mix individual nanoparticle standard solutions present in respective containers.

11. A method for automated handling of nanoparticle standard fluids for spectroscopy, comprising:
mixing, via an agitator, a nanoparticle standard solution in a container to provide a mixed nanoparticle standard having a substantially homogenous distribution of nanoparticles;
transferring, via a fluid line, the mixed nanoparticle standard to a fluid preparation system including a valve system and one or more pumps; and
directing, via the one or more pumps, the mixed nanoparticle standard through the valve system and into contact with a fluid sample stream to inline mix with the fluid sample stream and provide a mixed sample and nanoparticle standard fluid prior to transfer to an analysis system.

12. The method of claim 11, wherein the fluid preparation system further includes a nanoparticle standard loop, wherein the valve system includes a load configuration configured to fluidically couple the container with the nanoparticle standard loop.

13. The method of claim 12, wherein the one or more pumps include a vacuum loader, and wherein the valve system fluidically couples the vacuum loader with each of the nanoparticle standard loop and the container in the load configuration to permit the vacuum loader to draw the mixed nanoparticle standard into the nanoparticle standard loop.

14. The method of claim 12, wherein the valve system includes an inject configuration configured to fluidically couple the nanoparticle standard loop with the fluid sample stream.

15. The method of claim 14, wherein the valve system includes a valve having a mixing port that fluidically couples a fluid line configured to transfer the mixed nanoparticle standard from the nanoparticle standard loop with a fluid line configured to transfer the fluid sample stream to permit inline mixing between the mixed nanoparticle standard and the fluid sample stream to provide a mixed sample and standard fluid stream.

16. The method of claim 15, further comprising directing the mixed sample and standard fluid stream to the analysis system.

17. The method of claim 14, wherein the valve system fluidically decouples the nanoparticle standard loop from the container with the valve system in the inject configuration.

18. The method of claim 12, wherein the one or more pumps include a pump fluidically coupled with a working fluid source, the pump configured to introduce a working fluid from the working fluid source into the nanoparticle standard loop with the valve system in the inject configuration to push the mixed nanoparticle standard out of the nanoparticle standard loop.

19. The method of claim 11, wherein the valve system includes a purge configuration configured to fluidically couple with a purge gas source to direct purge gas through at least a portion of system.

20. The method of claim 11, further comprising selectively mixing individual nanoparticle standard solutions present in respective containers with the agitator.
